(19) United States
(12) Patent Application Publication
(10) Pub. No.: US 2024/0095483 A1
(43) Pub. Date: Mar. 21, 2024

(54) TWO LAYERS QR CODE LABEL ANTI-COUNTERFEITING SYSTEM

(71) Applicant: BrandsGuards Technology Co., Ltd., New Taipei City (TW)

(72) Inventor: KUO-SHEN LIU, New Taipei City (TW)

(21) Appl. No.: 17/949,194

(22) Filed: Sep. 20, 2022

(51) Int. Cl. G06K 19/06; G06K 7/14; G06Q 30/00

(52) U.S. Cl. CPC G06K 19/06093; G06K 7/1434; G06Q 30/0185; G06K 2007/10524

(57) ABSTRACT

A two layers QR code label anti-counterfeiting system includes a an outer QR code label and an inner QR code label that is arranged in a concealed manner and is paired with the outer QR code label for storage in a server. When a consumer proceeds with reading by applying an application program (APP) of a mobile phone, a QR code of the outer label is read first and after the reading, the mobile phone displays peeling off the outer QR code label to subsequently read a QR code of the inner label. The data of the two QR codes are transmitted by the mobile phone to the server for comparison with originally stored data to identify and determine genuineness or fakeness. In an attempt for determination of genuineness or fakeness for one more time or multiple times, it only needs to read the inner QR code label.

### TECHNICAL FIELD OF THE INVENTION

The present invention relates generally to a two layers quick response (QR) code label anti-counterfeiting system, and more particularly to a two layers QR code label anti-counterfeiting system that effectively achieves an anti-counterfeiting effect by reading two layers of a QR code label for subsequent transmission through a mobile phone to a server for comparison with originally stored data to identify whether it is authentic or fake.

### DESCRIPTION OF THE PRIOR ART

Product counterfeiting severely affects the interest of the original manufacturer and hinders the progress of the society. Thus, anti-counterfeiting is vital. Previously, measures of anti-counterfeiting include high-quality printing (of which an example is bank notes) or high-precision art (of which an example commercial product is Rolex watches), which make counterfeiting difficult. However, such known measures of anti-counterfeiting suffers at least the following two issues.

(1) The advance and progress of science and technology makes it easy to have machinery for producing high technology, and thus, counterfeiting is becoming easier.

(2) It is hard for the general consumers to identify if a product is genuine or fake even similarity between a fake product and a genuine product is only 70-80%, and consequently, there are still fake bank notes and fake Rolex watches readily available in the market.

The popularization of mobile phones makes it possible to use the mobile phone for the purposes of anti-counterfeiting, and recently developed counterfeiting recognition methods include NFC (Near Field Communication) and QR code labels. The NFC technology has been included in most of the currently available mobile phones and is implemented by transmitting an electromagnetic wave of 13.56 MHz from a mobile phone to be received by an NFC label, which in response, feeds back a message carried in the NFC label to allow the mobile phone to receive and interpret the message. The QR code is a two-dimensional barcode, and a mobile phone can be operated as a barcode reader by using a mobile phone or a specific application program (APP) thereof in order to read the message of the QR code. Considering the NFC label, there are two issues of concern:

(1) Cheap NFC chips can be easily duplicated, and this deteriorates the anti-counterfeiting effect thereof.

(2) High-end NFC chips that effectively prevents duplication, when used in combination with an antenna, require an extremely high overall cost, making it impractical for commercial products less than about US$100.00.

The QR code label is seemingly a low-cost anti-counterfeiting solution. However, the currently available QR code labels also suffer the following issues:

(1) Production of QR code labels is to have a half of a QR code label covered with a silver paste coating layer and then attached to a product of which protection against counterfeiting is desired. As shown in FIG. 1, a QR code label 10 is printed with a QR code 11, a silver paste coating layer 12, and an anti-counterfeiting manufacturer logo 13. To proceed with identification, the silver paste coating layer 12 is first scraped off, and the QR code 11 is read by a camera or a specific application program (APP) included in a mobile phone for transmission to a server to carry out an operation of identification. FIG. 2A shows an anti-counterfeiting QR code label 20A attached to a product of which protection against counterfeiting is desired, in which a silver paste coating layer has been scraped off and removed from a QR code 21A, and the QR code label 20A is printed with an anti-counterfeiting manufacturer logo 22A. A consumer, when proceeding with identification for anti-counterfeiting, uses a mobile phone 23A to read the QR code 21A, and if the QR code 21A matches data that has been previously loaded in a server 25, the product is identified as a genuine one, otherwise it is fake. Once it is identified as a genuine one, the mobile phone 23A displays a check mark (which is for example “1”) and a message that the product is genuine. This indicates that the product has been identified as a genuine one. However, a counterfeiter may first purchase a product that is protected against counterfeiting by means of a QR code label and then, after removing the silver paste coating layer, massively duplicates the QR code label for attaching to fake products, and consequently, the result of identification carried out by consumers would be exactly the same as that shown in FIG. 2A, meaning the counterfeited products are regarded as genuine ones. Thus, the effectiveness of a QR code anti-counterfeiting label works for just one time of reading and identifying. Once the product has been identified by one consumer and is then given to another person, the receiver of the product has no way to do identification for genuineness. On the other hand, if the consumer sells the product to a second buyer, then the second buyer has no way for proceeding with genuineness identification.

(2) As noted above, a QR code can be read by using a camera or a specific application program (APP) included in a mobile phone. However, it is generally hard for encouraging a large number of consumers to download the specific application program (APP), and thus, the currently available mobile phones mostly use the photographing function to do reading and identifying. This allows the counterfeiters to attach QR code labels that have a similar outer appearance but contain different information to fake products for scanning by the consumers and the information so scanned is transmitted to a server built up by the counterfeiters to receive a feedback message of being identified as a genuine product transmitted back to the mobile phone of the consumer. This would easily fool the consumer. FIG. 2B shows a counterfeit QR code label 20 attached to a product, in which a silver paste coating layer has been scraped off and removed, and information contained therein is different from that of the previously-discussed QR code 21A. However, since the logo 22B is identical to the logo 22A, the consumer may not be capable of identifying the difference between the two codes 21B, 21A, so that by this QR code 21B matching the data that has been previously loaded in the server 25B of the counterfeiters, the mobile phone 23B of the consumer will be signaled to display a check mark 24B (which is for example “1”) and a message that the product is genuine, indicating the fake product has been identified as a genuine one, and the consumer is thus fooled. However, if a specific application program (APP) is adopted for anti-counterfeiting identification, then the data read by the mobile phone is transmitted to the anti-counterfeiting server 25A, rather than the counterfeiters' server 25B, and the counterfeit QR code label 20B would be recognized as a fake QR code label. This clearly suggests that QR code genuineness identification should not be proceeded with by using the camera of a mobile phone, and instead, a specific application program (APP) must be adopted. Yet, it needs to first resolve the problem of encouraging the large number of consumers to download the specific application program (APP).

In view of the above, the present invention aims to develop a two layers QR code label anti-counterfeiting system, which effectively fulfills an effect of anti-counterfeiting by reading two layers of a QR code label for subsequent comparison with originally stored data to identify whether it is authentic or fake.

### SUMMARY OF THE INVENTION

The primary objective of the present invention is to provide a two layers QR code label anti-counterfeiting system that effectively fulfills an anti-counterfeiting effect by reading two layers QR code labels for subsequent transmission through a mobile phone to a server for comparison with originally stored data to identify whether it is authentic or fake.

The two layers QR code label anti-counterfeiting system of the present invention at least comprises an outer QR code label and an inner QR code label that is arranged in a concealed manner and the two codes is paired for storage in a server. When a consumer proceeds with reading by applying an application program (APP) of a mobile phone, a QR code of the outer label is read first and after the reading, the mobile phone displays peeling off the outer QR code label to subsequently read a QR code of the inner label, wherein data of the two QR codes are transmitted by the mobile phone to the server for comparison with originally stored data to identify and determine genuineness or fakeness, and wherein in an attempt for determination of genuineness or fakeness for one more time or multiple times, it only needs to read the inner QR code label.

In the above two layers QR code label anti-counterfeiting system, the inner QR code label and the outer QR code label are attached, in an arrangement of lapping each other, to a commercial product of which protection against counterfeiting is pursued, wherein the inner QR code label has a around half part covered by the outer QR code label and is not directly readable.

In the above two layers QR code label anti-counterfeiting system, the inner QR code label and the outer QR code label are separately and respectively printed on an internal package and an external package of the commercial product, and the inner-layer QR code is only readable after the outer-layer QR code of the external package is read and the external package is opened; and the data of the outer-layer QR code and the inner-layer QR code are read for comparison for identifying genuineness or fakeness.

In the above two layers QR code label anti-counterfeiting system, when the QR code of the outer QR code label read by the mobile phone is identified to be correct through the comparison conducted in the server, the mobile phone displays texts of “outer layer code is identified to be correct” and “outer QR code label must be peeled off within a predetermined period of time for subsequent scanning of inner QR code label to complete identification”.

In the above two layers QR code label anti-counterfeiting system, in case that the mobile phone of the consumer has not been loaded with the application program (APP), the consumer is allowed to use a camera function of the mobile phone to read one of the QR code labels, so that the consumer can be guided to download the application program (APP).

In the above two layers QR code label anti-counterfeiting system, the QR codes of the inner and outer QR code labels are paired and stored in advance in the server, and attaching of the inner and outer QR code labels is then implemented. This process may lead to erroneous label attaching in operation. The present invention further provides an ancillary code, which is paired with and printed below the inner-layer QR code and stored in the server. After the attaching of the outer QR code label has been done, in operation, a barcode is applied to read the outer-layer QR code and the ancillary code to for a pair for feeding to the server to be compared with the ancillary code that is paired with the inner-layer QR code. The server includes a software function to pair the inner-layer and outer-layer QR codes associated with the same ancillary code for storage in the server so as to avoid the concern of erroneous attaching.

In the above two layers QR code label anti-counterfeiting system, the ancillary code can be any kind of barcode and each ancillary code stored in the server is different. Further, to prevent leaking of the pairing relationship between the ancillary code and the inner-layer QR code, the ancillary code is automatically printed, in a random manner, below the inner layer code, and a barcode reader is applicable to automatically read the inner-layer QR code and the ancillary code for automatically pairing and storing in the server. As such, no human intervening is involved and thus no one knows the pairing relationship between the ancillary code and the inner-layer QR code. After the inner-layer QR code and the outer-layer QR code are paired and stored in the server, the ancillary code is deleted from the server, and after the deletion, can be re-paired with the QR code of a new inner QR code label for use.

### BRIEF DESCRIPTION OF THE DRAWINGS

FIG. 1 is a schematic view showing a known quick response (QR) code label.

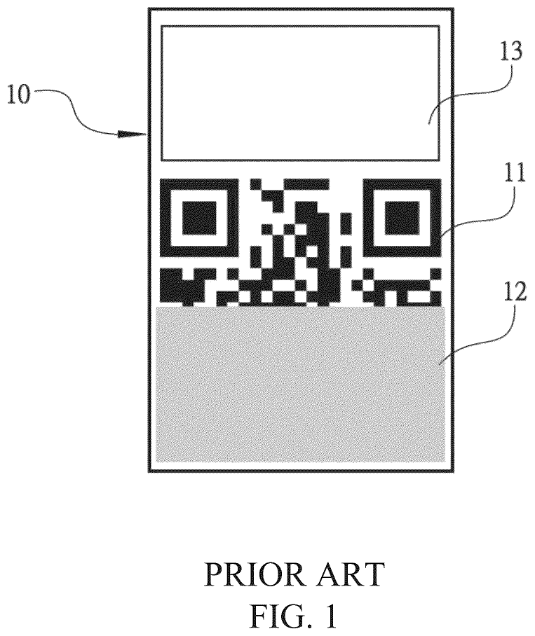

FIG. 2A is a schematic view demonstrating reading of the known QR code label.

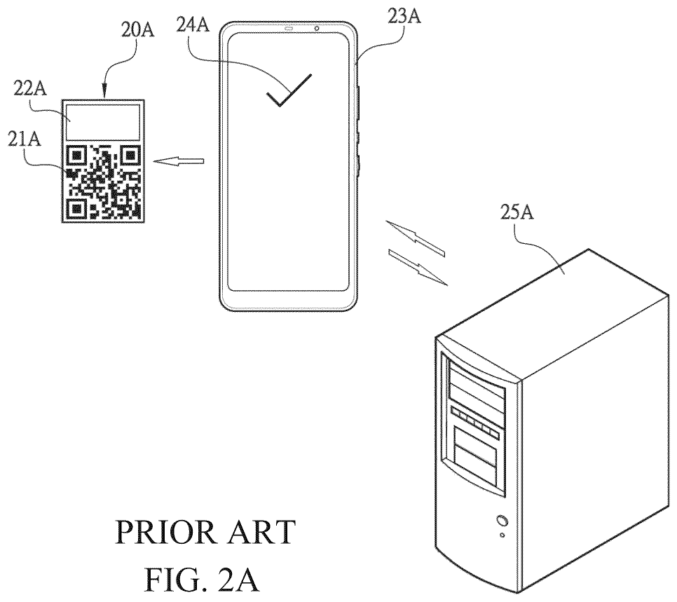

FIG. 2B is a schematic view demonstrating reading of a counterfeit QR code label.

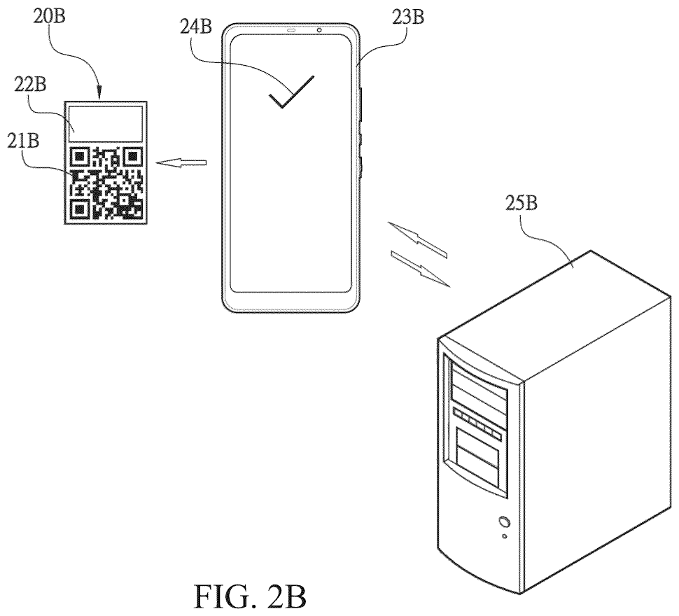

FIG. 3 is a schematic view showing a two layers QR code label according to the present invention.

FIG. 4 is a schematic view demonstrating reading of the two layers QR code label according to the present invention.

FIG. 5 is a schematic view demonstrating peeling off an outer layer code of the QR code label.

FIG. 6 is a flow chart illustrating a manipulation operation of the present invention.

FIG. 7 is a schematic view illustrating another application of the present invention.

FIG. 8 is a schematic view showing an ancillary code-attached two layers QR code label according to the present invention.

FIG. 9 is a schematic view demonstrating peeling off an outer layer of the ancillary code-attached QR code label.

### DETAILED DESCRIPTION OF THE PREFERRED EMBODIMENT

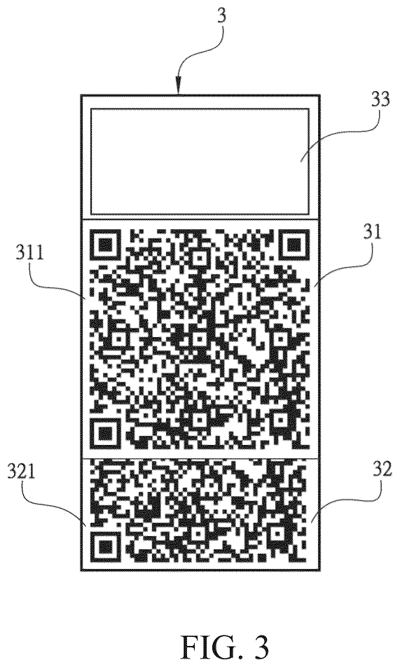

Referring to FIG. 3, which is a schematic view showing a two layers QR code label according to the present invention, as shown in the drawing, the two layers QR code label 3 according to the present invention at least comprises an outer QR code label 31 that includes an outer-layer QR code 311 and an inner QR code label 32 that includes an inner-layer QR code 321 and is arranged in a concealed manner for being paired with the outer QR code label 31 to store in a server. In the instant embodiment, the inner QR code label 32 and the outer QR code label 31 are generally of the same size, and the outer QR code label 31 and the inner QR code label 32 are arranged to lap each other as being stacked together, so that approximately around one half of an area of the inner QR code label 32 is covered and shielded by the outer QR code label 31 and is thus not directly observable; the outer QR code label 31 is arranged in a peelable manner, and the peeling does not cause any damage to the inner QR code label 32 and would allow a consumer to see and find that there is further the inner QR code label 32, and thus naturally knowing that there is a need to read the inner QR code label 32; and an upper part is printed with an anti-counterfeiting manufacturer logo 33, in order to allow the stacked outer QR code label 31 and inner QR code label 32 to be attached to a commercial product of which protection against counterfeiting is desired.

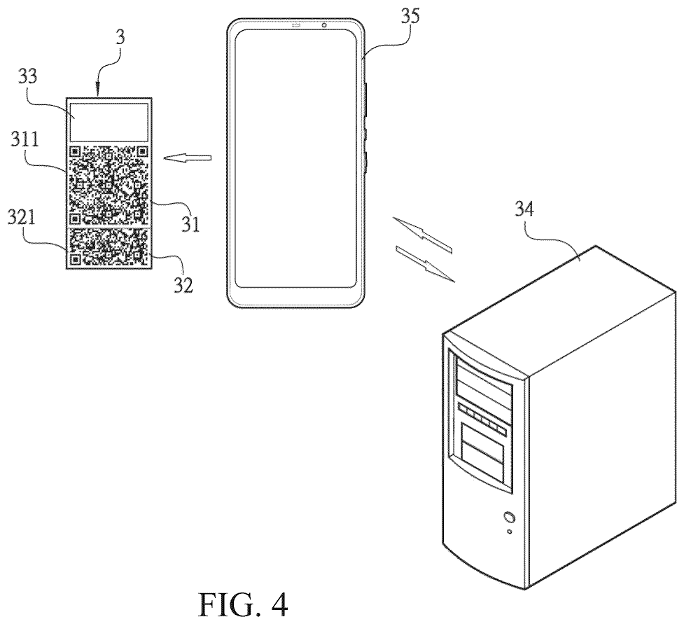

Referring to FIG. 4, which is a schematic view demonstrating reading of the two layers QR code label according to the present invention, reference being also had to FIG. 3, as shown in the drawings, each of the outer-layer QR code 31 and the inner-layer QR code 32 contains a unique data, and the data of the outer-layer QR code 31 and that of the inner-layer QR code 32 are stored in pair in a server 34, and are recognizable by the server 34 as to which one is the outer-layer QR code 311 and which one is the inner-layer QR code 321. The present invention is such that when a consumer performs reading with a camera or a specific dedicated application program (APP) of a mobile phone 35, only the outer-layer QR code 311 is initially read out, and after the reading, the mobile phone 35 displays and advises the consumer to peel off the outer QR code label 31 for subsequently reading the inner-layer QR code 321 of the inner QR code label 32, so that the data of the outer-layer QR code 311 and that of the inner-layer QR code 321 are transmitted by the mobile phone 35 to the server 34 to compare with originally stored data for identifying for being genuine or fake, thereby effectively fulfilling an effect of anti-counterfeiting. If there is a need for such identifying for being genuine or fake to be implemented one more time or multiple more times, what is necessary to do is reading the inner-layer QR code 321.

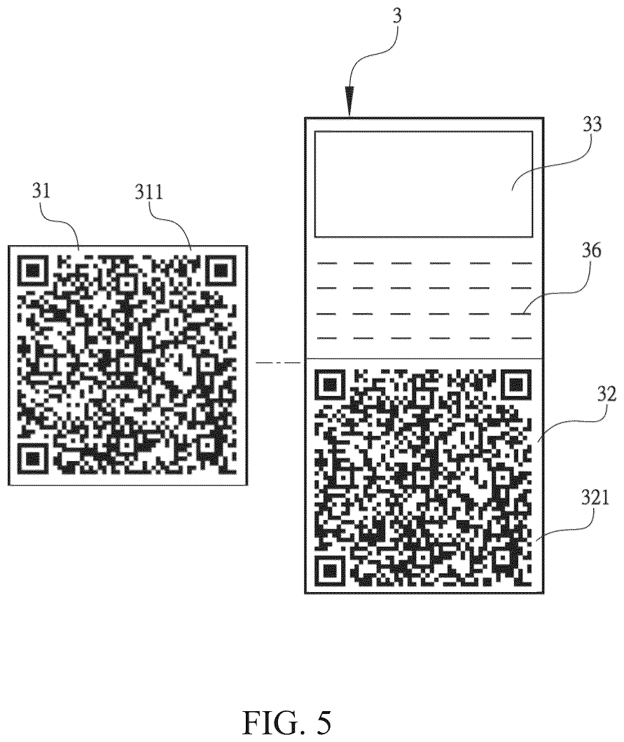

Referring to FIG. 5, which is a schematic view demonstrating peeling off an outer layer code of the QR code label, as shown in the drawing, the present invention is such that after the consumer peels off the outer QR code label 31, advice texts 36 indicating “outer layer code has been identified by initial buyer to be correct and has been peeled off” or “outer layer code has been identified by initial buyer to be correct and has been opened” are exhibited to allow a subsequent identifier (who can be a gift acceptor or a second-hand product buyer) to get aware that the outer QR code label 31 being peeled off is a normal rule.

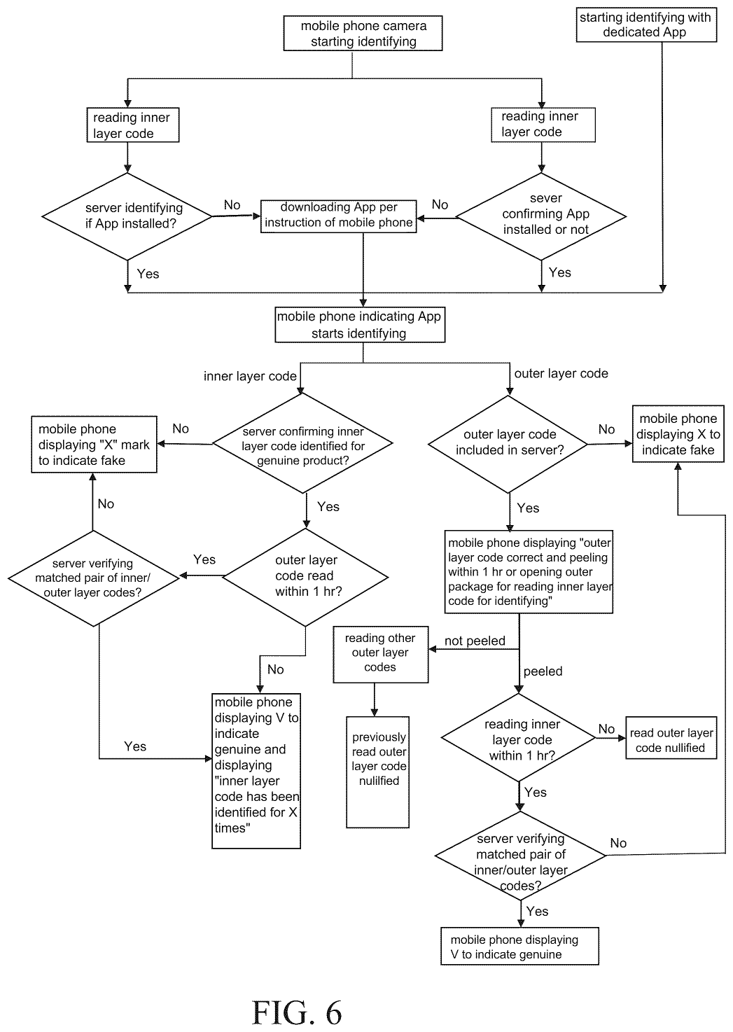

Referring to FIG. 6, which is a flow chart illustrating a manipulation operation of the present invention, reference being also had to FIGS. 3-5, the operation of the present invention mainly comprises the following steps:

(1) A consumer operates a camera function of a mobile phone 35 to carry out identifying.

(2) If the mobile phone 35 is loaded with an application program (APP), then an operation of identifying is immediately started, otherwise if no application program (APP) is downloaded, the camera function of the mobile phone 35 is activated to read one of an outer-layer QR code 311 and an inner-layer QR code 321 to guide the user to download an application program (APP).

(3) After the mobile phone 35 completes the downloading of the application program (APP), the operation of identifying is started.

(4) When the consumer reads the outer-layer QR code 311 with the mobile phone 35, if a server 34 finds no such a code therein, then the mobile phone 35 is instructed to display a symbol (such as a marking of X) or texts to indicate this is a fake product; and if the server 34 finds such a code therein, then the mobile phone 35 is instructed to display the following text: “outer layer code is correct and outer QR code label 31 must be peeled off within some hours (such as one hour) to scan inner-layer QR code 321 of inner QR code label 32 before identifying is completed” to notify the consumer that identifying for genuine or fake is implemented by first scanning the outer-layer QR code 311 and then scanning the inner-layer QR code 321; and in case that displaying indicates this is genuine immediately after the scanning of the outer-layer QR code 311, the consumer can immediately determines that the commercial product is in fact a fake one.

(5) If the inner-layer QR code 321 has not been read after the reading of the outer-layer QR code 311, then it becomes failure after some hours (such as one hour).

(6) When both the outer-layer QR code 311 and the inner-layer QR code 321 have been scanned, if the server 34 verifies the two codes are matched ones, the mobile phone 35 is instructed to display a symbol (such as “,”) to indicate this is genuine, or texts “this is genuine” are displayed. If verification by the server 34 indicates non-matching, then the mobile phone is instructed to display a symbol (such as “X”) to indicate this is a fake product, or texts “this is fake” are displayed.

(7) When the server 34 has recorded that the outer-layer QR code 311 and the inner-layer QR code 321 have been correctly identified, if the inner-layer QR code 321 is read again, then the mobile phone 35 similarly displays “˜” to indicate a genuine product, or displays texts of “this is genuine”, and meanwhile, the mobile phone 35 also displays “this is inner layer code and has been read for x times”; if an initial buyer purchases a new product, yet the inner-layer QR code 321 has been directly read without reading the outer-layer QR code 311 first, and it is displayed on the mobile phone 35 to indicate that this code so read is an inner-layer QR code 321, then it can be immediately determined that the product is in fact a fake one.

(8) When the server 34 has recorded that the outer-layer QR code 311 and the inner-layer QR code 321 have been correctly identified, if the outer-layer QR code 311 has been read again, then the mobile phone 35 displays a marking of “X” to indicate this is a fake product, or texts of “this is fake” are displayed.

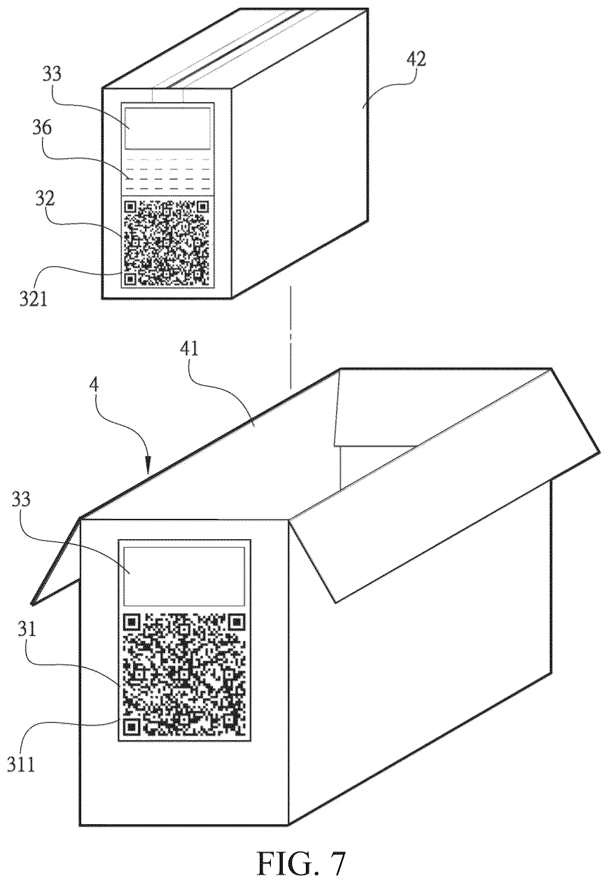

Referring to FIG. 7, which is a schematic view illustrating another application of the present invention, as shown in the drawing, the present invention is applicable to a commercial product 4 that includes both an external package 41 and an internal package 42, in which the outer-layer QR code 311 is printed on an external package 41, and the inner-layer QR code 321 is printed on an internal package 42. After the outer-layer QR code 311 on the external package 41 has been read, the external package 41 can only be opened to reveal and read the inner-layer QR code 321 printed on the internal package 42, so that data of the outer-layer QR code 311 and the inner-layer QR code 321 are read for comparison to identify for genuine or fake, to thereby fulfill a function of anti-counterfeiting similar to that of the two layers QR code label 3.

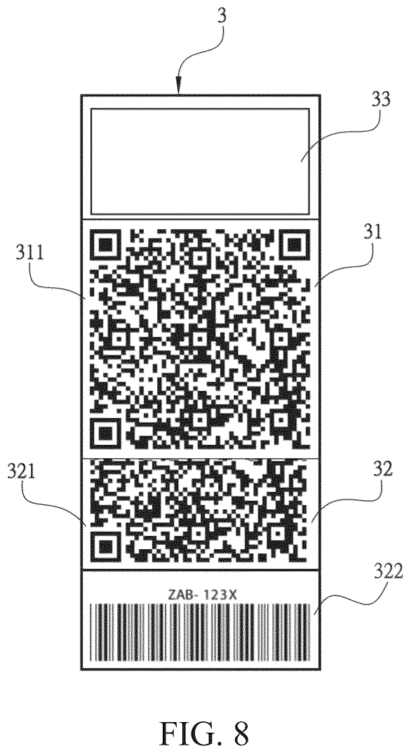

Referring to FIG. 8, which is a schematic view showing a two layers QR code label according to the present invention that is attached with an ancillary code, as shown in the drawing, the present invention is such that for the inner QR code label 32 being attached with the ancillary code 322, in operation, a barcode scanner is used to read the outer-layer QR code 311 and the ancillary code 322 to form a pair fed to the server 34 for comparison with an ancillary code that pairs with the inner-layer QR code and is previously stored in the server 34, to prevent erroneous attachment of labels. The server 34 includes a software function that stores an inner-layer QR code 321 and an outer-layer QR code 311 associated with the same ancillary code in the server 34.

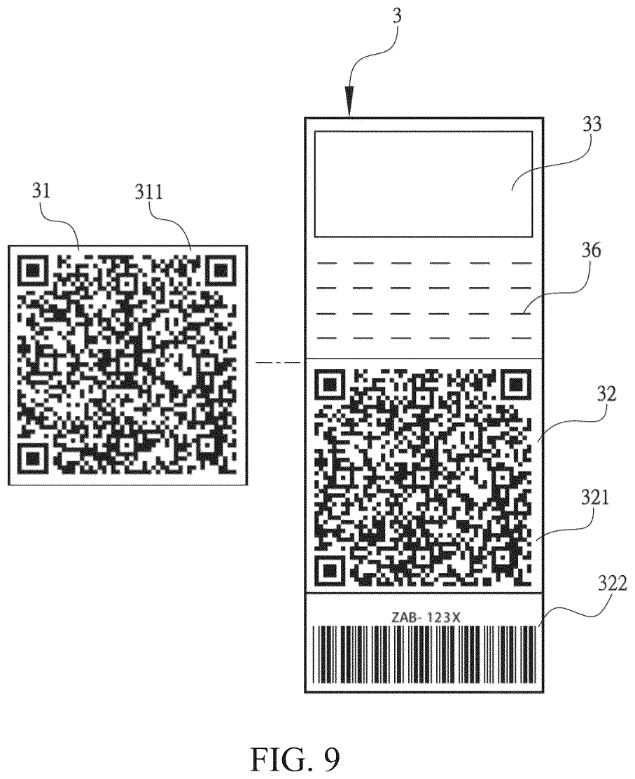

Referring to FIG. 9, which is a schematic view demonstrating an outer QR code label being peeled off an ancillary code-attached label according to the present invention, as shown in the drawing, the present invention is such that for not leaking an association paired relationship of an ancillary code 322 and an inner-layer QR code 321, the ancillary code 322 is automatically printed, in a random manner, under the inner-layer QR code 321, and a barcode reader can be applied to automatically read the inner-layer QR code 321 and the ancillary code 322 to be then stored in the server 34. Since there is no human intervening, there is no person knowing the pairing relationship between the ancillary code 322 and the inner-layer QR code 321. The ancillary code 322 as described above can be a barcode of any form and each of the ancillary codes 322 stored in the server 34 is different. After the inner-layer QR code 321 and the outer-layer QR code 311 have been paired and stored into the server 34, the ancillary code 322 is deleted from the server 34, and after the being deleted, can be re-paired with the inner-layer QR code 321 of a new inner QR code label 32 in the same way as discussed above.

The embodiment provided above is only for illustrating a preferred way of embodying the present invention and is not intended to limit the scope of the present invention. Minor modifications and variations can be made without departing from the gist of the present invention and are considered within the spirit of the present invention.

In summary, the present invention provides a two layers QR code label anti-counterfeiting system that is formed of an outer QR code label including an outer-layer QR code and an inner QR code label that is arranged in a concealed manner and paired with the outer QR code label to be stored in a server. The two layers QR code label is read and transmitted by a mobile phone to the server for comparison with originally stored data to identify for being genuine or fake to thereby fulfill an effect of anti-counterfeiting.

1: A two layers quick response (QR) code label anti-counterfeiting system, at least comprising an outer QR code label and an inner QR code label that is arranged in a partly concealed manner and is paired with the outer QR code label, wherein a QR code of the outer QR code label and a QR code of the inner QR code label are paired together and stored in a server; the inner QR code label and the outer QR code label are lapped with each other and attachable to a commercial product of which protection against counterfeiting is implemented, and around half of the inner QR code label is covered by the outer QR code label and the OR code of the inner OR code label is partly covered by the outer OR code layer and at least a part of the OR code of the inner OR code label is exposed, the OR code of the inner OR code label and the OR code of the outer OR code label being both visible, so that when a consumer proceeds with reading by applying an application program (APP) of a mobile phone, the outer-layer QR code of the outer QR code label is first read, and after the reading, the mobile phone displays and notifies to peel off the outer QR code label to subsequently read the inner-layer QR code of the inner QR code label, data of the outer-layer QR code and the inner-layer QR code being transmitted by the mobile phone to the server for comparison with originally stored data to identify if the commercial product is genuine or fake and to display a symbol on the mobile phone to indicate genuineness or fakeness.

2: The two layers QR code label anti-counterfeiting system according to claim 1, wherein a size of the outer QR code label is around identical to a size of the inner QR code label.

3: The two layers QR code label anti-counterfeiting system according to claim 1, wherein the inner QR code label comprises texts of “outer QR code label has been identified by initial buyer to be correct and has been peeled off” or “has been identified by initial buyer to be correct and has been opened” printed thereon, so that a reminder is provided to the consumer after the outer QR code label is peeled off.

4. (canceled)

5: The two layers QR code label anti-counterfeiting system according to claim 1, wherein when the QR code of the outer QR code label read by the mobile phone is identified as correct during comparison conducted in the server, the mobile phone displays texts of “outer layer code has been identified to be correct” and “outer QR code label must be peeled off within a predetermined period of time or the external package be opened for scanning inner QR code label to complete identification”.

6. (canceled)

7: The two layers QR code label anti-counterfeiting system according to claim 1, wherein if the mobile phone of the consumer does not include the application program (APP) downloaded therein, a camera function of the mobile phone is operable to read one of the outer-layer QR code and the inner-layer QR code to initiate a process of guiding the consumer to download the application program (APP).

8: The two layers QR code label anti-counterfeiting system according to claim 1, wherein an ancillary code is printed on the inner QR code label below the inner-layer QR code in a manner of being paired therewith or being made randomly, so that in operation, a barcode reader is operated to read the outer-layer QR code and the ancillary code as a pair for transmission to the server for comparison with an ancillary code that is previously stored in the server and paired with the inner-layer QR cod, in order to prevent erroneous label attaching.

9: The two layers QR code label anti-counterfeiting system according to claim 8, wherein the ancillary code is printed, in a manner of being made randomly, below the inner-layer QR code and the inner-layer QR code and the ancillary code are readable by the barcode reader to combine as a pair for storage in the server.

10: The two layers QR code label anti-counterfeiting system according to claim 8, wherein the ancillary code comprises a barcode, and each ancillary code is different.
